(19) United States
(12) Patent Application Publication
(10) Pub. No.: US 2004/0107809 A1
(43) Pub. Date: Jun. 10, 2004

(54) Automatic feed system for tube shear device and position registration system for same

(76) Inventor: John J. Borzym, Northville, MI (US)

Correspondence Address: Thomas N. Young, YOUNG & BASILE P.C., Suite 624, 3001 W. Big Beaver Road, Troy, MI, 48084, US

(21) Appl. No.: 10/310,194

(22) Filed: Dec. 4, 2002

(51) Int. Cl. B26D 3/00; B26D 5/00; B23D 21/00

(52) U.S. Cl. 83/54

(57) ABSTRACT

An automatic tube shearing system of the type requiring no shearing blades comprising an automatic two-stage tube feed mechanism and a bladeless shear. The feed mechanism comprises a tube loader, a pinch roller type initial drive, a selectively engageable main roller drive and an intermittent drive including a gripper which operates in a precision fashion to feed tube through the shear apparatus. The shear apparatus is of the type requiring tooling, both externally and internally of the tubing to prevent deformation during the bladeless shear operation. The internal tooling comprises a mandrel having a position stabilization rod extending along the tube end feed path and equipped with a pair of spaced apart latches which operate in a complemental fashion to permit tube lengths to be fed onto the mandrel rod and later fed through the shear without ever unlocking the stabilization rod and losing the proper positioning of the mandrel. A unique tube clamp and several methods of using the apparatus to provide substantially continuous tube feed are disclosed. A method of verifying the registration of the lead end of a tubular workpiece with a shear plane is disclosed.

### FIELD OF THE INVENTION

This invention relates to systems for feeding tubular steel stock and similar workpieces to a shear, and more particularly to methods and apparatus for ensuring accurate length control in the finished product.

### BACKGROUND OF THE INVENTION

Tubular stock is used as a basic raw material in the manufacture of many products including automotive exhaust systems, automotive drive line components, furniture, bicycles, fencing, and conduit. Tubular stock is typically manufactured in a semi-continuous process by roll-forming flat stock, seam welding and cutting to manageable lengths such as twenty feet. The stock is then shipped to fabricators who re-cut the stock to desired lengths.

A suitable recut apparatus is disclosed in U.S. Pat. No. 4,635,514, issued Jan. 13, 1987, to Alexander Borzym. The Borzym apparatus, described herein as a “supported shear,” comprises two axially adjacent ring-like tools which surround a tubular workpiece with a special mandrel disposed internally therein. A drive system causes one of the two ring-like tools to move through an orbital path while the other remains in place. The mandrel is constructed with two axially-adjacent parts which can move radially relative to one another. The interface between them is colocated with the interface between the two ring-like tools along what is known as the “shear plane.” The orbital movement is effective to break or shear the tubing along the shear plane without the loss of material which is produced by a saw or guillotine blade.

A system for feeding lengths of tubing into and through an apparatus of the type described above is disclosed in my prior U.S. Pat. No. 6,123,003, issued Sep. 26, 2000. In that system, each tube length is first “registered” by closing the shear and bringing the lead end of the tubing to the shear plane. Closing the shear; i.e., displacing the movable tool relative to the fixed tool, creates a mechanical obstruction which establishes the shear plane. By bringing the lead end of the tubing to the shear plane, the tubing is “registered” in a known start position. All subsequent command length feeds can be taken from the registered position.

Various problems can occur if the tube is not correctly registered. Incorrect registration can occur if the lead tube end is not square (planar and orthogonal to the tube axis) or if the feed apparatus has not properly and effectively gripped and fed the tube forward to the shear plane.

An erroneous, short registration; i.e, a registration procedure which fails to bring the tube end all the way to the shear plane, will produce a first cut length which is too short. If this first length is intended for use in a fabricated product, it must obviously be scrapped. If the first cut length is intended as a “crop cut,” a short feed toward the pre-established crop length may result in no crop cut at all or, worse yet, jamming the shear apparatus by trying to crop cut with too little material through the shear plane.

### SUMMARY OF THE INVENTION

The principal objective of my invention is to provide methods and apparatus for verifying the occurrence of a good tube-end registration in a system at least generally of the type shown in my prior U.S. Pat. No. 6,123,003. In general, this is accomplished by operating a feed mechanism intended to move a length of tubing or other similar workpiece to a shear plane, detecting the presence or absence of the tubing a known distance from the shear plane, generating a data signal having a sense or value indicating whether or not a tube was detected and thereafter operating the same or a different feed mechanism to move the tube along a feed path until the sense of the signal changes.

In the preferred form, the first and second feeds are performed by different mechanisms of different characters. In addition, I place an optical detector a known distance such as 5.6″ downstream from the shear plane. After each lead end registration, I then feed the tube forward 5.7″. If the detector “sees” a tube, a good registration is presumed to have occurred and I can then either reverse feed to a crop cut length or forward feed to the desired first cut length minus 5.7″. If the detector does not “see” a tube, registration was not correctly achieved and appropriate measures, such as system shutdown, are taken.

In another embodiment, I place the detector in an upstream position to look for the trailing end of the tube after registration. This approach requires that each registered tube be of a predetermined length and is not suitable where substantial variations in tube length occur.

A first and preferred method aspect of my invention involves position registering the lead end of a tube relative to a shear plane by operating a feed mechanism the normal function of which is to advance a tube along a feed path to a shear plane at a time when the shear tooling is closed to create an obstruction in the feed path. The tooling is then opened to remove the obstruction and a feed mechanism operates to advance the tube a known distance beyond the shear plane which distance is such that the lead end of a properly fed tube is just past a sensor location. The sensor then determines whether or not the tube is present. If the tube is present, then the system will continue with the operation by either reversing the feed mechanism to perform a crop cut or, in the event a crop cutting is not required, to move the tube forward a specified amount before shearing the tube at the required length. If the tube is not detected by the sensor, then a gripper mechanism attempts to feed the tube forward until either the sensor output changes or the gripper runs out of travel. If the gripper has moved forward full travel and the sensor still has not sensed the tube, an alarm is signaled to call the operator to diagnose the problem for corrective action.

A second illustrative method includes placing one or more sensors upstream of the shear plane at locations which correspond generally but are spaced slightly from one or both ends of a known length of the tube stock to be sheared. The method of position registering the lead end of the tube relative to the shear plane includes operating a feed mechanism to advance the tube along the feed path such that the leading end of the tube should be at the shear plane, then using the sensor or sensors to detect the presence or absence of a tube end at a position where a properly fed tube will produce a signal of known sense; e.g., a sensor which produces a negative (−) signal when cleared by a properly fed tube of the proper length produces a positive (+) error signal if the tube is either too long or incorrectly fed.

A gripper portion of the feed mechanism can then attempt to move the tube forward until either the sensor locates the trailing end of the tube or until the gripper runs out of travel. An alarm will signal the operator if the trailing end of the tube has not passed the trailing end sensor after the feed mechanism has advanced the tube to the shear plane and the gripper has advanced through its maximum travel.

After the tube registration has been verified, the feed mechanism is advanced a short distance for crop cutting, if crop cutting is desired. Otherwise, the feed mechanism advances the tube a desired amount for establishing the length of the tube to be sheared. The method continues advancing and shearing until the tube is too short for further shearing.

My invention as well as the various detailed apparatus aspects and the method aspects thereof may be best understood and appreciated from a reading of the following specification which describes an overall system as well as detailed components of the system and methods of operation thereof. Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a schematic diagram of an overall automatic feed and shear system incorporating the apparatus aspects of my invention and being operable in accordance with the first method aspects of my invention;

FIG. 2 is a schematic diagram of an overall automatic feed and shear system incorporating the apparatus aspects of my invention and being operable in accordance with the second method aspects of my invention;

FIG. 3 is a detail of the main drive in the “feed” portion of the system of my invention; and

FIG. 4 illustrates the gripper apparatus which is employed in the automatic feed system of my invention.

### DETAILED DESCRIPTION OF THE ILLUSTRATIVE EMBODIMENTS

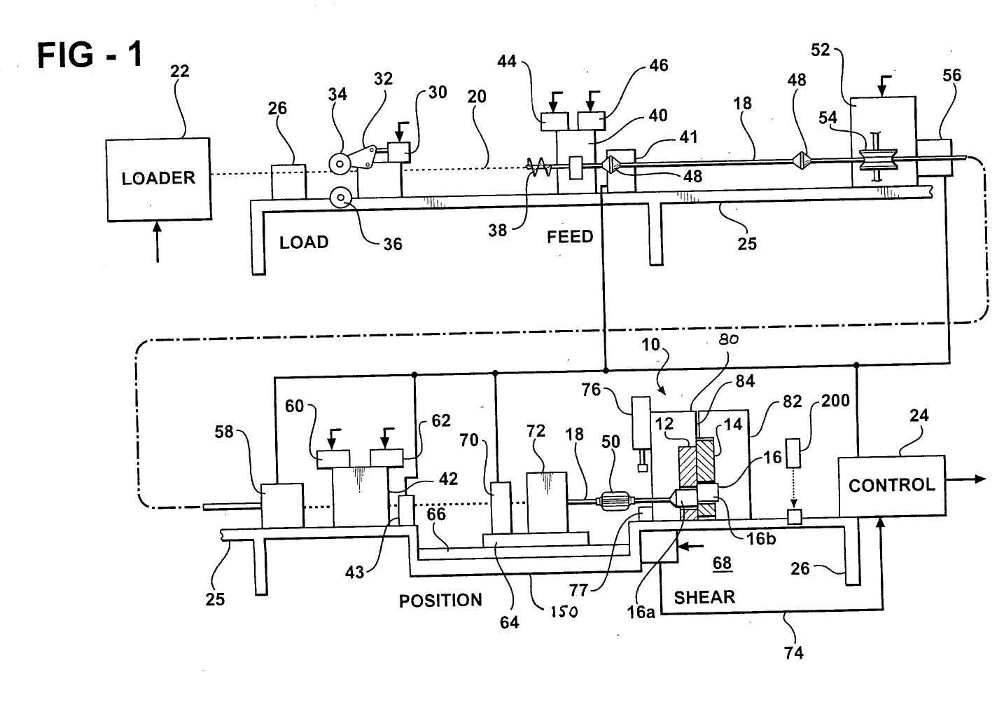

Referring first to FIG. 1, I illustrate schematically the components and the layout of a system for automatically feeding twenty foot lengths of welded steel tubing through a bladeless shear apparatus 10 of the type having external tooling 12, 14 and an internal mandrel 16 mounted on a mandrel support rod 18 which extends from the shear 10 back along a tube feed path 20 a distance of approximately 30 feet. It will be understood that the dimensions, distances, capacities, feed rates and other numerical data given in this specification, unless otherwise indicated, are for purposes of illustration and are not to be construed in a limiting sense. The system shown in FIG. 1 is schematically divided linearly into four sections which are denominated “LOAD,” “FEED,” “POSITION,” and “SHEAR,” respectively. Flow of tubular stock through the system is from the LOAD section to the SHEAR section.

A loader 22 is adapted to receive and accumulate a dozen or more lengths of tubular stock in a strap sling or cradle which is manipulable to feed tubular stock onto a ramp which is belt driven to cause the tubes to roll up against a fixed mechanical stop where they are held until a signal is received from a controller 24. The controller 24 is a state-of-the-art industrial controller of the type which includes a programmable microprocessor and storage for applications software to carry out the methods described herein. The controller essentially responds to specific input signals to enable specific outputs as will be apparent to skilled artisans. The controller output causes the loader to lift individual lengths of tubular stock over the mechanical stop and drop the lengths, one at a time, onto a series of spaced high speed drive rollers which advance the tube toward a support table 25 which underlies essentially all of the hereinafter described apparatus including the shear 10 and which is essentially coextensive with the tube feed path 20. The loader 22 is essentially a known device usable in combination with virtually any type of tube re-cut machine as will be apparent to those knowledgeable in and with the tube fabrication technologies. The support table 25, although shown as a single, integral device, may be created by the assembly of several fabricated devices such as weldments or other structures. Support 25 may also include a direct tube support device of the type disclosed in U.S. Pat. No. 6,352,012.

Tubular stock advanced toward and into the tube feed path 20 by the loader 22 encounters a photocell 26 which is so located as to produce a signal, one state representing the presence of a tube and the other state representing the absence of a tube. In the typical operation method, a look-up table in the controller 24 responds to the input to generate an output activating the in-feed drive cylinder 30 to rotate a link 32 thus causing a roller 36 to engage the outer surface of the tube and advance it toward the entry end of the mandrel rod 18. Drive roller 36 works in conjunction with selectively operated pinch roller 34.

A spiral wire bristle brush 38 is removably secured on and to the entry end of the mandrel rod 18 to clean the internal diameter of the advancing tubular stock. Just downstream of the brush 38 is a mandrel lock 40, the first of two essentially identical mandrel locks 40, 42 spaced linearly apart in the system of FIG. 1 by a distance which is greater than the maximum length of tubular stock to be accommodated. Mandrel lock 40 comprises two controller activated power cylinders 44 and 46 which are operated in sequence for purposes to be described to latch and release the mandrel rod 18. As will hereinafter be made apparent, the controller 24 issues commands to the mandrel locks 40 and 42 in such a way that one of the two locks is operative to latch the mandrel rod and maintain its axial, longitudinal position with great precision at all times.

The mandrel rod 18 has installed thereon, in addition to the spiral de-burring brush 38, a number of spaced steel forms 48 and 50 the outer diameters of which approximate the inner diameter of the tubing. These forms 48, 50 operate in combination with an infeed support table of the type described in U.S. Pat. No. 6,352,012 to support the mandrel rod 18 and prevent it from sagging so as to mislocate the mandrel relative to the shear plane. The first form 48 is essentially the same diameter as the body 50 and is, therefore, a “qualifying” form for effectively rejecting undersized tube. Subsequent forms 48 may be slightly smaller in diameter. The form 50 is of greater length and of an overall design which is somewhat different than the forms 48 because it is located in the area where successive tubes which are simultaneously in the system of FIG. 1 abut one another during certain operations hereinafter described.

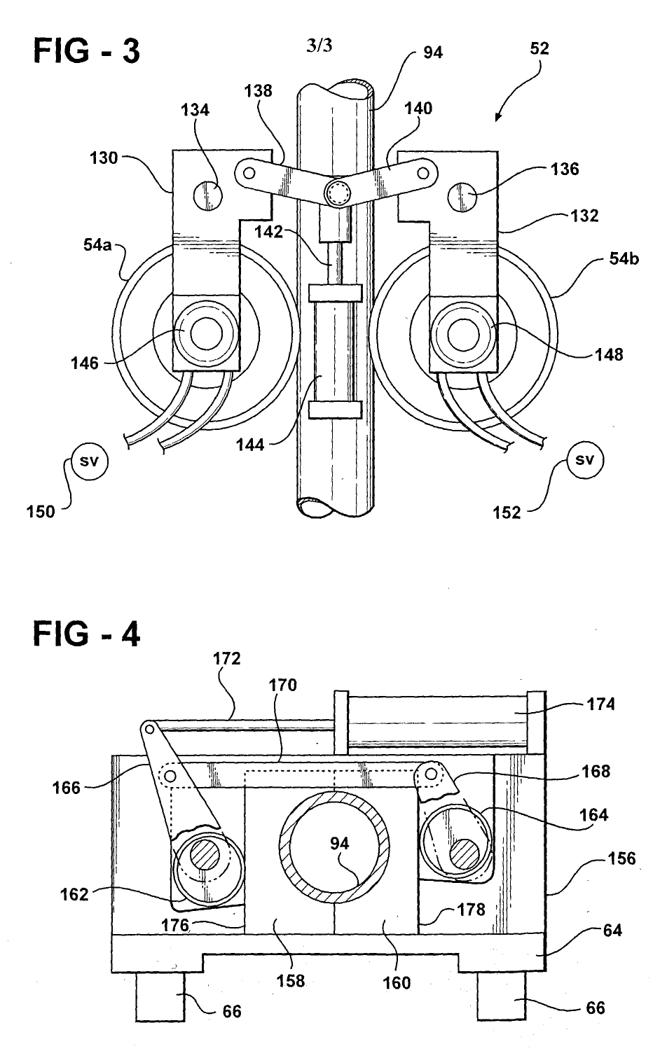

Downstream of the mandrel lock 40 is the main roller drive mechanism 52 comprising a pair of selectively outwardly movable pinch rollers 54 which operate under the control of the controller 24 to engage and disengage lengths of tubular stock and feed them unidirectionally but at selected and different speeds toward the shear 10. Details of the main roller drive mechanism 52 are illustrated in FIG. 3. Downstream of the main drive 52 is a limit switch 56 which is of a conventional type to be engaged by advancing tubular stock to produce an electrical signal of binary character which is connected via bus 28 to an input of the controller 24. Additional limit switches 41 and 43 are located on support 25 just downstream of the mandrel locks 40 and 42 respectively. These switches signal the controller 24 that the trailing tube end has cleared the mandrel.

Also disposed on the support 25 and downstream of the main roller drive 52 is an additional limit switch 58 producing an output signal which is connected to an input of the controller 24. Just downstream of limit switch 58 is the second mandrel lock 42. Mandrel lock 42 comprises sequentially activated cylinders 60 and 62 which receive commands from the controller 24 according to a program of operations hereinafter described. Arrival of the entry end of a tube at switch 56 signals the controller 24 to start a high speed advance for a pre-set time calculated (on the basis of known tube length) to bring the lead end of the tube near switch 58. The drive reverts to a low speed drive at this point. Movement forward from switch 58 is also timed to bring the lead end right up to lock 42.

Limit switch 58 and mandrel lock 42 are in the “FEED” or staging portion of the system. The “POSITION” portion of the system includes an aluminum platform type carriage 64 which is mounted on a pair of parallel spaced apart precision steel rails 66 mounted on a level bed 150 for incremental and bi-directional movement under the control of a ball screw type AC motor carriage drive 68 the input commands to which are received from the controller 24 in a known fashion. Mounted on carriage 64 is a limit switch 70 the function of which is to produce a signal to the controller 24 which indicates the high speed approach of the lead end of a length of tubular stock into the “POSITION” portion of the system. This signal operates, according to a program stored in the microprocessor memory of the controller 24, to reduce the operating speed of the main drive 52 such that the tube advances toward a reference position for purposes hereinafter described at a substantially lower rate of travel.

Just downstream of the limit switch 70 along the tube feed path 20 is a precision gripper/feeder 72 hereinafter referred to simply as the precision feed 72. The gripper portion of the precision feed 72 is illustrated in more detail in FIG. 4 to include components which are capable of gripping and holding a length of tubular stock with sufficient force and with such little slip as to make it highly likely that the position of the carriage 64, once a position reference has been established, is an accurate representation of the position of the tubular stock relative to the shear plane defined by and in the shear apparatus 10. As shown in FIG. 1, a conventional feedback signal is fed by way of line 74 from the reversible carriage drive 68 to the controller 24 such that the controller 24 is aware of; i.e., has data indicating the position of the carriage 64 along the rails 66 relative to the position reference at all times. The rollers 54 of the main drive 52, on the other hand, permit slip so as to prevent damage to the system components and/or the tubular stock in the event of minor collisions and to allow the high and low speed advances of the tubing by the main drive rollers 54 to be conducted on a timed basis rather than on the basis of precision position control as is the case for the carriage mounted components 70, 72 in the system of FIG. 1. Position feedback information from the “FEED” system to the controller 24 comes from the limit switches 41, 43 and 56.

By way of further explanation, it will be apparent to those skilled in the electronics and position control art that the limit switch typically detects and signals only the presence or absence of a physical article at a given position at any given time. On the other hand, a AC motor driven ball screw position drive such as that used at 68 to control the position of the carriage 66 can be combined with very high resolution signal transducers such as digital shaft angle encoders to provide data on the absolute position of a physical object within a known path of permissible travel at any given time.

An hydraulic clamp 76 is mechanically mounted on the frame of the shear 10 over the tube feed path 20 in the vicinity of the form 50 to clamp tubular stock to maintain the position reference; i.e., the positional relationship between the tubular stock and the shear plane, whenever the precision feed 72 releases the tube and moves in the reverse direction; i.e., to the left as shown in FIG. 1, to start another incremental advance toward the shear 10. The clamp 76 is otherwise released to permit tubing to be fed into and through the shear 10. Clamp 76 operates against a tube seat 77.

Details of the shear 10, the associated external tooling 12, 14 and the internal mandrel 16 can be obtained from a reading of the aforementioned U.S. Pat. Nos. 4,635,514, 6,123,003 and 6,352,012 which are incorporated by reference. However, for purposes of achieving an immediate fundamental understanding of the physical character and operation of the shear and its associated tooling, the following information is offered.

The shear 10 comprises a first heavy steel ram 80 which, during the shearing operation, is fixed to a reference frame or base which is coextensive with the support 24 as shown in FIG. 1. Ram portion 80 carries hardened steel ring tool 12 having a throughbore of a diameter which accepts in close contact relationship the outside surface of the tubular workpiece to be severed to length. An internal clearance of 0.012″ or less is preferred. A second movable ram 82 is disposed in adjacent relationship with the first ram 80, the interface between the tools 12 and 14 defining a shear plane 84. Ram 82 carries hardened steel tool 14 which abuts tool 12 along the shear plane 84. Tool 14 is also formed with a circular aperture conforming essentially to the outside diameter of the tubing to be operated upon. Whereas ram 80 and tool 12 are stationary, ram 82 and insert 14 are laterally displaceable through an orbital path illustrated in FIG. 1 under the control of a powerful bidirectional drive 78 the details of which are fully described in U.S. Pat. No. 6,352,012 having the same filing date as this application, the disclosure of which is incorporated herein by reference. The relative displacement between the tools 12 and 14 is approximately equal to the wall thickness of the tubular stock and, in combination with the internal forces which are created by the mandrel 16, is operative to shear the tubular stock along the shear plane in a clean, minimally distorting and slugless fashion. The mandrel 16, as illustrated in FIG. 1, must be designed and constructed in such a fashion as to permit longitudinally adjacent portions 16a and 16b to displace radially of one another nearly to the same extent as the inserts 12 and 14 displace radially relative to one another. It can be seen and appreciated in FIG. 1 that the interface plane between the internal tooling components 16a and 16b should be precisely coextensive with the shear plane 84 at all times as any other relationship produces an inferior cut quality. This is why the mandrel 16 is associated with the stabilization rod 18 and why one or both of the mandrel locks 40 and 42 must be activated to hold the position of the rod 18 and the mandrel 16 at all times during operation of the shear 10. Of course, the mandrel 16 and rod 18 may be removed from the system for repair or replacement purposes as will be apparent to those skilled in the machinery arts.

A sensor 200 of the type having a light beam transmitted from a transmitter portion and received at a receiver portion is used for sensing the tube position. The output of the sensor changes sense; i.e., from zero to one or from negative to positive, when the beam is broken by a solid object passing between the transmitter and the receiver. The sensor 200, as shown in the embodiment depicted in FIG. 1, is located a known distance downstream of the shear plane and is used for verifying whether the leading end of the tube has been positionally registered at the shear plane. The tube is registered by feeding the leading end of the tube to the shear plane, and making a processor entry to the effect that the lead end is at the shear plane. To check or verify the registration, the tube is then moved forward past the location of sensor 200 to verify registration. If the output of sensor 200 is such as to confirm that a tube is present, the registration is verified and the tube shearing process continues. If no tube is seen by sensor 200, the controller determines that a good registration did not occur. The feed process is stopped and an alarm sounded.

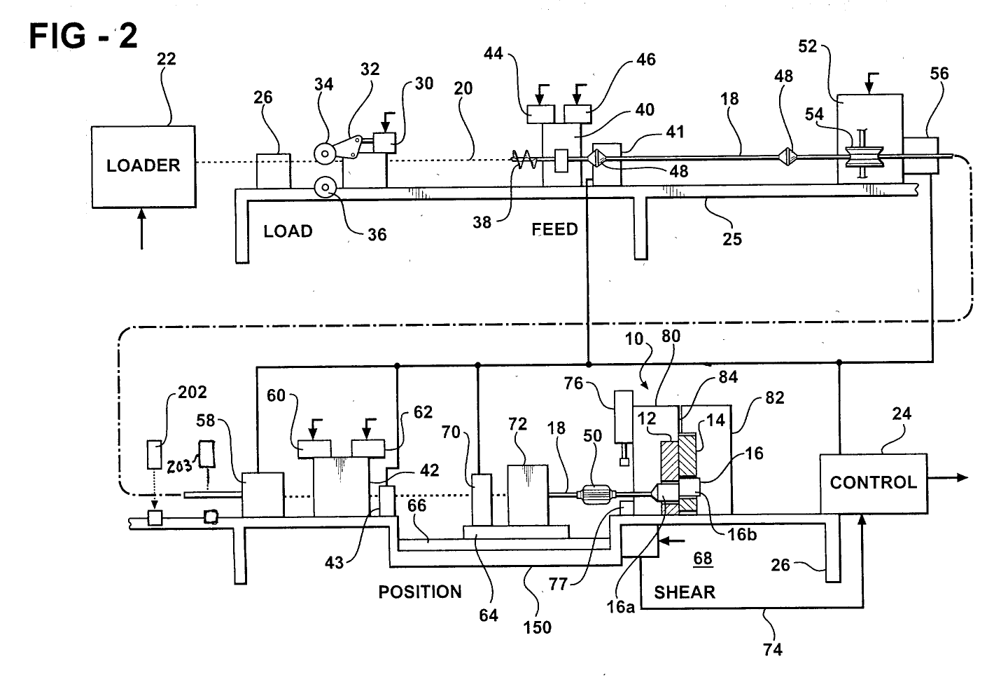

Referring now to FIG. 2, sensors 202 and 203 are used in an alternate embodiment for verifying that a tube is properly position registered relative to the shear plane. In this embodiment, the sensors 202 and 203 are located just downstream of the high-speed roller drive 52, but far enough upstream of the shear plane such that the trailing end of properly registered tube stock of known length will completely pass the sensor 202 when it has been properly registered at the shear plane but not pass sensor 203. The registration is verified if, after the tube stock has been brought to the shear plane, the beam from the sensor 202 is not broken by the trailing end of the tube but the beam from sensor 203 is broken.

Referring now to FIG. 3, the detail of the main roller drive will be described in greater detail. The main drive 52 comprises left and right drive rollers 54a and 54b which can be closed and opened to grip and release the tube 94 as desired. Rollers 54a and 54b are mounted on rigid L-shaped links 130 and 132 having respective pivot points 134 and 136 relative to the support 24. Links 130 and 132 are connected by intermediate links 138 and 140 respectively to the output plunger 142 of an hydraulic actuator 144. Advancing the plunger 142 upwardly as shown in FIG. 3 closes the rollers 54 on the tube 94; vertically downward movement of the plunger 142 as shown in FIG. 3 opens the main drive to disengage the drive rollers 54 from the tube. The rollers themselves are connected to hydraulic drive motors 146 and 148, respectively, which rotate the rollers in opposite directions to drive the tube 94 toward the shear 10. The drive is preferably bidirectional. It will be understood by those skilled in the hydraulic control arts that solenoid controlled valves 150 and 152 are appropriately connected into the hydraulic control lines to the motors 146 and 148 to respond to signals from the controller 24.

Referring now to FIG. 4, the details of the gripper portion of the precision feed mechanism 72 will be described. The gripper mechanism comprises a base carriage 64 mounted on slide rails 66 which are seated on the bed 50 which represents a mechanical ground. Mounted on carriage 64 is frame 156 of which the two pieces are complementally movable inwardly and outwardly and carry respective grippers 158 and 160, the internal surfaces of which are arcuately machined to conform to the outer diameter of the tube 94 as shown. Eccentric roller bearings 162 and 164 are pivotally connected to the frame 156 on opposite sides of the tube center line and spaced so as to engage the left and right vertical surfaces 176 and 178 of the grippers 158 and 160, respectively. The rollers 162 and 164 fit into pockets in the gripper carrier frame 156 so as to positively urge the grippers apart when rotated in the opposite direction. The two slidable parts of the frame 156 rest on the carriage 64 and are preferably maintained in proper alignment by way of a pair of guide pins (not shown). Again, refer to U.S. Pat. No. 6,352,012 for details.

Eccentric roller 162 is connected to a link 166 whereas roller 164 is connected to a link 168. The two links 166 and 168 are tied together by means of a cross link 170 and the entire arrangement is connected to an output plunger 172 of nearest cylinder 174. The arrangement is configured such that the extension of the plunger 172 from right to left as shown in FIG. 4 closes the gripper inserts 158 and 160 to clamp the tube 94. Conversely, movement of the plunger 172 from left to right as shown in FIG. 4 positively opens the gripper inserts. No springs or other such devices are required. Rollers 162 and 164 operate in the manner of cams and have considerable mechanical advantage.

There are numerous advantages to the arrangement shown in FIG. 4. One of these advantages is the fact that use of a fluid cylinder provides a cushion that prevents damage to the apparatus of FIG. 4 in the event there is an obstruction which prevents closing of the gripper inserts 158 and 160 on the tube 94; i.e., air in the cylinder 174 simply compresses and the gripper inserts remain open to the degree necessary to accommodate the obstruction. Another advantage is that a single unidirectional stroke of the cylinder 174 drives the grippers 158 and 160 in opposite directions through the eccentric 162 and 164. The rollers are contoured to operate in opposite sense when rotated in the same direction; i.e., the larger radius of cam 162 measured from the pivot point is in approximately the 4 o'clock position whereas the larger radius of cam 164 is in the 10 o'clock position as shown in FIG. 4. Details of the shear 10 including the clamp 76 and the opposing seat 77 and the drive 78 are omitted from this description that may be found in U.S. Pat. No. 6,352,012.

Methods of Operation

Method No. 1

As a first example, it will be assumed that a 20 foot length of tubular stock is fed into the system by the operation of the loader 22, is picked up by the photocell 26 and advanced by the in-feed drive 30, 32, 34. The tubular stock is fed over the brush 38 and onto the mandrel rod 18. Controller 24 is advised by photocell 26 of the advance of the tubular stock and sets the mandrel locks 40 and 42 such that mandrel lock 40 is “OPEN” and mandrel lock 42 is “CLOSED”; in this instance the term “OPEN” means that the lock is released from the rod 18 to permit the passage of the tube. There being no prior length of tubing in the system, in-feed drive 30, 32, 34 continues in operation until the 20 foot length of tube reaches the main drive 52, an event which is signaled by the limit switch 56 sending a signal to the controller 24. The controller 24 outputs a command closing the rollers 54 and setting the main drive for high speed operation which is timed to bring the lead end to the switch 58 as previously described. Then a low speed operation advances the tube lead end to lock 42.

Three additional conditioning steps are carried out: first, the mandrel lock 42 is opened; second, the carriage 64 is advanced to the most forward position; i.e., to the position of its travel closest to the shear 10 and, third, the shear 10 is incrementally operated by the drive 78 to offset the insert 14 relative to the insert 12. This latter condition is known as “closing” the shear in that it creates a mechanical obstruction to the passage of the tubular stock all the way through the shear 10. It also provides a position reference by permitting the lead end of the tubular stock to be brought into contact with the obstructing forward wall of the insert 14 such that the lead end of the tubular stock is precisely located at the shear plane. This is the “zero” reference position and all subsequent and cumulative forward movement of the precision feed 72 and the carriage 64 relative to the fixed rails 66 are measured from this zero reference position. Lock 42 is opened when the trailing end clears switch 41. Lock 40 is closed at the same time. The tube is advanced to switch 70.

Passage of the trailing tube end by switch 43 tells the controller 24 that it is time to close the mandrel lock 42 and open the mandrel lock 40 to permit the next tube to be loaded.

The contact of the first advancing tube with the limit switch 70 indicates to the controller 24 that it is time to reduce the speed of advance of the tubular stock as it is about to encounter, in this case, the closed shear tooling at the zero reference position. Again, the rough position of the lead end of the tube is calculated as a function of time, any error in actual position being accommodated by the fact that some slip is permitted between the rollers 54 and the outer surface of the tubular stock.

The step of advancing the carriage 54 to the forwardmost position has the advantage of placing the limit switch 70 at a position which is the farthest downstream permitted by the mechanical design of the system and thus, the most efficient in terms of establishing the time at which the controller switches from high speed advance to low speed advance conditions. After establishing the position reference, the precision feed 72 takes over by (a) activating the hydraulic clamp 76 to clamp the tube in position and (b) retracting the carriage 64 to the left most position as shown in FIG. 1 with the precision feed rollers in the open condition; i.e., the tube is maintained in the “home” position wherein the lead end of the tubular stock abuts the insert 14 at the shear plane 84. When fully retracted, the precision feed rollers (shown in FIG. 3) are closed and the hydraulic clamp is released.

At this time, the sensor 200 does not detect a tube. Its output is, therefore, of a sense or value which indicates to the controller that no tube is present. The tube is then fed forward a known distance just past the location of sensor 200 so that the sensor 200 can confirm that the leading end of the tube has been correctly registered. For example, if the sensor 200 is located 5.6 inches downstream of the shear plane, the tube will be advanced 5.7 inches past the shear plane. If the beam of sensor 200 is broken, its output changes sense. This is interpreted by the controller that registration of the tube was proper. The tube can be reversed using the feed mechanism for allowing leading end tube crop cut, if desired. If the leading end is known to be of good quality and already cut squarely, the tube can be moved forward a full cut length minus 5.7″ so that the correct length of tube can be sheared with the shearing mechanism. The tube will continue to be fed forward and sheared at the desired length until the original tube stock has been cut down to a size smaller than the desired length.

Method No. 2

An alternate method for position registering a lead end of a tube is shown in FIG. 2. The sensors 202 and 203 are located just downstream of a high-speed roller 52, but positioned upstream a distance just slightly greater than the desired length of the tube stock to straddle the trailing end of a properly registered tube. With this method, the tube leading end is advanced to the shear plane and the sensors 202 and 203 verify that the trailing end is between the sensor locations. The beam of sensor 202 should be continuously broken as the tube passes the sensor location while being advanced to the shear plane. Once the leading end of the tube reaches the shear plane, the output of the sensor 202 should change sense but the output of sensor 203 does not. This is interpreted by the controller that the tube is properly registered at the shear plane. Once properly registered, the tube can be moved forward with the gripper mechanism 72 for crop cutting and subsequent shearing of the correct lengths of tube. If crop cutting is not required, then the tube can be moved forward with the gripper mechanism 72 and sheared at the desired length.

If the sensor 200 is not triggered by the leading end of the tube in the first method, or the sensor 202 still detects the trailing end of the tube in the second method, the gripper portion of the feed mechanism 72 will be advanced until the leading end of the tube is detected in the first method or until the trailing end of the tube is removed from the beam of sensor 202 in the second method. If neither of these conditions is satisfied, the gripper 72 will continue to move forward until it runs out of travel, at which time an alarm is signaled so that an operator can physically check the tube position and/or determine whether the system is calibrated correctly.

It is to be understood that the foregoing embodiments have been described for purposes of illustration and to conform to the patent laws in enabling a person of ordinary skill in the art to build and use an apparatus incorporating the various inventions as described hereinabove.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method of verifying the registration of the lead end of a tubular workpiece with a shear plane defined by shear tooling comprising the steps of:
operating a feed mechanism intended to advance the workpiece along a feed path toward the shear plane;
detecting the presence or absence of the workpiece with a sensor located at a position which is a known distance from the shear plane;
generating a data signal from the sensor having a sense indicating a result from the detecting step; and
operating a feed mechanism to advance the workpiece along the feed path until the sense of the signal changes.

2. The method of claim 1 further comprising the steps of:
operating the feed mechanism to advance the tube a distance X beyond the shear plane; and
determining whether or not the tube is present at the sensor location using a sensor located X-Y from the shear plane, where X>Y.

3. The method of claim 1 further comprising the step of:
moving a gripper portion of the feed mechanism forward until the sensor locates a leading end of the tube or until the gripper runs out of finite travel.

4. The method of claim 3 further comprising the step of:
signaling an alarm if the sensor is not triggered when the feed mechanism has advanced a distance X past the shear plane after registering the leading end of the tube at the shear plane and after the gripper has advanced forward to the end of the travel.

5. The method of claim 1 further comprising the steps of:
reversing the feed mechanism after successfully position registering the tube if crop cutting is desired; and
crop cutting the end of the tube with the shear mechanism.

6. The method of claim 1 further comprising the steps of:
advancing the feed mechanism a desired amount after successfully position registering the tube for establishing the length of the tube to be sheared if crop cutting is not required; and
shearing the tube at the desired length with the shear mechanism.

7. An apparatus for position registering the lead end of a tube relative to a shear plane defined by shear tooling comprising:
a feed mechanism for advancing a tube along a tube feed path to a shear plane;
a controller in communication with sensors, actuators, and other movable machinery for controlling the tube shearing operation;
a shearing mechanism located downstream from the feed mechanism for shearing the tube to the desired length; and
a sensor located downstream from the shear plane for determining if a tube is positioned at a desired location and for communicating the position information to the controller.

8. The apparatus of claim 7, wherein the sensor is a photocell having a transmitter and receiver that can sense whether the beam being transmitted by the transmitter is blocked by a solid object.

9. The apparatus of claim 7, wherein the feed mechanism further comprises:
a high speed section that includes a pair of opposing spinning rollers located downstream of the front of the apparatus for contacting opposing sides of the tube and moving a tube quickly to a gripper section located near the shear plane of the apparatus.

10. The apparatus of claim 7, wherein the feed mechanism further comprises:
a relatively slow speed gripper section operably attachable to a geared sliding table located upstream of the shear tooling, the gripper designed to securely hold the tube and accurately position the tube relative to the shear tooling based on controller and sensor feedback.

11. The method of claim 1 further comprising the steps of:
advancing the tube to a shear plane when the shear tooling is closed; and
determining whether or not a trailing end of the tube has moved past a sensor located upstream of the shear tooling a distance greater than a known length of tube.

12. The method of claim 1 further comprising the step of:
moving the tube forward with a gripper portion of the feed mechanism until the sensor locates a trailing end of the tube or until the gripper runs out of a finite travel.

13. The method of claim 12 further comprising the step of:
signaling an alarm if the sensor is not triggered by the passing of the trailing end of the tube when the feed mechanism has advanced the tube to a shear plane and after the gripper has advanced forward to the end of the travel.

14. The method of claim 1 further comprising the steps of:
operating the feed mechanism to advance the tube after successfully position registering the tube if crop cutting is desired; and
crop cutting the end of the tube with the shear mechanism.

15. An apparatus for position registering the lead end of a tube relative to a shear plane defined by shear tooling comprising:
a feed mechanism for advancing a tube along a tube feed path to a shear plane;
a controller in communication with sensors, actuators, and other movable machinery for controlling the tube shearing operation a shearing mechanism located downstream from the feed mechanism for shearing the tube to the desired length; and
a sensor located upstream from the shear plane for determining if a tube is positioned at a desired location and communicating the information to the controller.

16. The apparatus of claim 15, wherein the sensor is a photocell having a transmitter and receiver that can sense whether the beam being transmitted by the transmitter is blocked by a solid object.

17. The apparatus of claim 15, wherein the feed mechanism further comprises:
a high speed section that includes a pair of opposing spinning rollers located downstream of the front of the apparatus for contacting opposing sides of the tube and moving a tube quickly to a gripper section located near the shear plane of the apparatus.

18. The apparatus of claim 15, wherein the feed mechanism further comprises:
a relatively slow speed gripper section operably attachable to a geared sliding table located upstream of the shear tooling, the gripper designed to securely hold the tube and accurately position the tube relative to the shear tooling based on controller and sensor feedback.
